(19) United States
(12) Patent Application Publication
(10) Pub. No.: US 2026/0161776 A1
(43) Pub. Date: Jun. 11, 2026

(54) CROSS-NAMESPACE RISK ASSESSMENT

(71) Applicant: Microsoft Technology Licensing, LLC, Redmond, WA (US)

(72) Inventors: Achindra BHATNAGAR, Hyderabad (IN); Ahmet Ibrahim AKSOY, Prague (CZ); Abhik SEN, Bengaluru (IN); Nilesh Vijay AWATE, Hyderabad (IN)

(21) Appl. No.: 19/002,834

(22) Filed: Dec. 27, 2024

(30) Foreign Application Priority Data
Dec. 7, 2024 (IN) 202411096860

(51) Int. Cl. G06F 21/55; G06F 21/57

(52) U.S. Cl. CPC G06F 21/554; G06F 21/577

(57) ABSTRACT

Some embodiments receive events in a computing system, map the events to one or more namespaces in which the events occurred, determine a relationship between the namespace(s), and factor in the namespace relationship as well as the events themselves when they assess a security risk posed by the events. For example, namespaces that share an ancestor namespace tree root below a global root are related. Some embodiments map an event to an event process and then to a namespace creation process, and finally to a namespace. Some embodiments match events which occurred in different container namespaces to an attack pattern, thereby detecting an attack that would have been missed at that point by treating events in different namespaces as uncoordinated with each other.

### RELATED APPLICATION

The present application claims priority to, and incorporates by reference the entirety of, India provisional patent application No. 202411096860 filed Dec. 7, 2024.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by identifying and closing security gaps, and by forcing attackers to encounter multiple different kinds of security mechanisms at multiple different locations around or within the computing system. No single security mechanism is able to identify every vulnerability or detect every kind of cyberattack, able to determine the scope of an attack or a vulnerability, able to remove every vulnerability, and able to end every detected cyberattack. But sometimes combining and layering a sufficient number and variety of defenses and investigative tools will prevent an attack, deter an attacker, or at least help limit the scope of harm from an attack or a vulnerability.

To implement defense in depth, some computing systems address different kinds of attacks that could be made, and different vulnerabilities the computing system may have. Defenses are sometimes based on criteria such as: which attacks are most likely to occur, which attacks are most likely to succeed, which attacks are most harmful if successful, which other defenses are in place, which defenses could be put in place, and the costs, procedural changes, and other impacts involved in putting a particular defense in place or removing a particular vulnerability to attack. Some defenses investigate the scope of an attack, and some try to detect vulnerabilities before they are exploited. Some defenses or investigations might not be feasible or cost-effective for a particular computing system. However, improvements in cybersecurity remain possible, and worth pursuing.

### SUMMARY

Some embodiments address technical challenges arising from the malicious use of containers and other namespace separation mechanisms. One challenge is how to assess risk, when different parts of an attack are sometimes coordinated to occur in different namespaces. Another challenge is how to determine which namespace(s) events occurred in, when visibility into some namespaces is restricted. Other technical challenges are also addressed herein.

One example embodiment taught herein detects events in a computing system. For each event in a set of events, the embodiment determines a namespace in which the event occurred, and ascertains whether the events occurred in different namespaces than each other. The embodiment calculates a risk score from at least one of the events and from at least the namespace(s). Then the embodiment performs a cybersecurity operation according to at least the risk score.

In an example scenario, the risk assessment proceeds as though events were coordinated with each other even though the events occurred in different namespaces than each other, because the namespaces share an ancestor, e.g., they are nested within the same container namespace. In this scenario, the occurrence of events in separate namespaces is a risk-neutral factor or a risk-increase factor, not a risk-decrease factor.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems, including some aspects generally suitable for enhanced systems which include or use cross-namespace risk assessment (CNRA) functionality;

FIG. 2 is a block diagram illustrating aspects of a first example family of enhanced systems which are each configured with CNRA functionality;

FIG. 3 is a dataflow diagram of a second example family of enhanced systems which are each configured with CNRA functionality;

FIG. 4 is a diagram illustrating process identifiers and namespaces in a computing system;

FIG. 5 is a block diagram illustrating a map data structure in a computing system which implements associations between process identifiers and namespace identifiers;

FIG. 6 is a diagram illustrating a hierarchy of process identifiers and a corresponding hierarchy of namespace identifiers, in a computing system;

FIG. 7 is a reproduction of a portion of a process tree diagram generated by a pstree command;

FIG. 8 is a reproduction of another portion of the process tree diagram of FIG. 7;

FIG. 9 is a second relationship diagram illustrating process identifiers, namespaces, and namespace identifiers in a computing system;

FIG. 10 is a block diagram of some mechanisms, data structures, contextual items, characteristics, and other aspects of cross-namespace risk assessment in some enhanced systems;

FIG. 11 is a first flowchart illustrating some CNRA methods;

FIG. 12 is a second flowchart illustrating some CNRA methods; and

FIG. 13 is a flowchart further illustrating CNRA methods, and incorporating as options the steps of FIG. 12, the steps of FIG. 11, and other steps disclosed herein.

### DETAILED DESCRIPTION

### Overview

Some teachings described herein match technical challenges faced and insights gained during efforts to improve security tools for Microsoft Windows® Subsystem for Linux® (WSL™) software (Windows and WSL are marks of Microsoft Corporation; Linux is a registered mark of Linus Torvalds). However, the teachings herein are not limited in their scope or applicability to this particular software, or to these particular challenges, solutions, or insights.

WSL allows a given system to run both Linux commands and Windows commands, which substantially increases the programming options available on that system. Unfortunately, for years both Windows environments and Linux environments have been targets of attacks by threat actors. Security tools are available for each environment, including some tools originally implemented in Windows environments which have been ported to WSL Linux environments. These security tools are helpful, but they faced a visibility gap due to the use of virtualization mechanisms such as containers.

The term “container” is used in various ways, but in the present disclosure “container” refers to a particular kind of software virtualization mechanism. A container allows software to run in an isolated user space. A container includes an application program and any code the application program is configured to invoke upon execution of the application program, such as digital resources and other code dependencies, software libraries, system software tools, and a runtime program. Containers are lightweight in that they share an underlying machine's operating system kernel, so they do not include a copy of the kernel in each container; this distinguishes containers from virtual machines, which do include a kernel copy per virtual machine. Tools for container orchestration or container management include, for example, Docker® software (mark of Docker, Inc.), Kubernetes® software (mark of The Linux Foundation), and Podman (short for pod manager) software developed by Red Hat® engineers and the open source community (Red Hat is a mark of Red Hat, Inc.).

Although Linux environments are used as an example herein, containers also run in other environments. Linux environments are examples of Unix®-like environments, also sometimes referred to as *nix environments (UNIX is a registered mark of The Open Group). Most if not all *nix environments permit containers. Containers also run in some Windows environments.

One characteristic of many *nix systems is the presence of a root namespace which presents a global view of the system. The root namespace is where all processes exist by default if they are not explicitly placed in a separate namespace. The root namespace is the primary and original namespace when the *nix system boots up.

A container has its own namespace, which can be used by attackers to hide malicious work from some security tools. For example, some security tools will not detect a keylogger running inside a container. Keyloggers record keystrokes, including any passwords or other sensitive information typed into a system. Without sufficient visibility into the container, a security tool will not detect that keystrokes are being recorded. Moreover, without an adequate hook into the container, or some kind of trap or other mechanism that passes execution control from the container to the security tool, the security tool cannot intervene (e.g., to block a file exfiltration upload) even if the tool detects malicious activity in the container.

One approach to the problem of malware running in containers is to prohibit containers. This prevents the use of containers to hide malicious activity, because it prevents the use of containers for anything. But this approach also prevents programs and developers from obtaining the benefits of containers, such as agile software development, efficient operation (e.g., by avoiding storage of multiple copies of the kernel), portability to different environments, parallelism in program execution, and isolation of programs from external malicious code and from accidental undesirable interactions with one another.

Another approach permits containers, but includes a copy of security tools within each container so the tools have visibility into the activities inside the container. This approach helps prevent the use of containers to hide malicious activity, but also reduces the benefits of containers, by making them significantly larger. Duplicating the security tools so there is a complete copy of the tools in each container is not an efficient use of memory. Moreover, this approach is vulnerable to coordinated malicious activity across containers, e.g., when malware in one container begins an attack and malware in another container finishes the attack, and neither container's security tool sees enough on its own to detect the attack. A combination of events across namespaces fails to raise an alert even though the same combination in a single namespace would raise an alert.

Some embodiments described herein take a different approach, referred to here as cross-namespace risk assessment (CNRA). Containers are permitted by CNRA, with mechanisms taught herein being employed to provide visibility into the containers and to permit intervention against malicious code running in a container. Moreover, some embodiments detect malicious activity that is coordinated across containers.

For example, some CNRA embodiments establish a nesting relationship between container namespaces, and collapse nested namespaces to a single container root namespace. Some detect a security threat action based on at least two different processes which run in different namespaces that have the same root namespace. In one example scenario, an example embodiment detects an unknown binary listing all files in a first namespace, detects creation in a second namespace of an archive which contains compressed copies of multiple listed files, and detects in a third namespace a command to upload the archive to a location on the internet. This embodiment determines that the first, second, and third namespaces are coordinated in that each is a descendant of the same root namespace, and performs a security mitigation action, e.g., blocks the upload.

Some embodiments described herein utilize or provide a cybersecurity method performed by a computing system. This CNRA method includes: detecting at least two events in the computing system; for each event in a non-empty set of events, determining a namespace in which the event occurred; ascertaining whether the events occurred in different namespaces than each other; calculating a risk score from at least one of the events and from at least a result of the ascertaining; and performing a cybersecurity operation according to at least the risk score.

This CNRA functionality has a technical benefit of improving security by calculating the risk score not merely from events but also from namespaces. When the ascertaining result indicates that the events occurred in a single namespace, familiar risk assessment mechanisms are still applicable. However, unlike some tools, an embodiment is not limited to mechanisms that assume all events occurred in the same namespace.

In some scenarios, the ascertaining result indicates that the events occurred in two or more different namespaces. When a set of events matches an attack pattern, then the risk score is calculated accordingly as a higher value than if the events did not match any known attack pattern. A higher risk score is calculated in particular if a higher possibility of event coordination is indicated by the presence of a single shared ancestor namespace other than the system's root namespace, e.g., when the events' namespaces are nested within the same container.

In short, this CNRA functionality plugs a hole in risk assessment by factoring in the events' namespaces, not merely the events themselves.

Although containers are used as examples, herein, this capability is applicable in systems that do not necessarily include containers, e.g., in systems that run nested virtual machines.

In some embodiments, namespaces in the computing system are arranged in a namespace hierarchy which includes a root namespace and at least one non-root namespace; the at least two events occurred outside the root namespace; and the detecting includes receiving the at least two events in the root namespace. For instance, some embodiments inject a thread into a process that has a non-root namespace. The thread is configured to upon execution acquire a handle, and the detecting detects events in the root namespace via the handle.

This CNRA functionality has a technical benefit of improving security by extending the coverage of security tools that operate in the root namespace. Instead of, or in addition to, detecting events in the root namespace, the CNRA-enhanced security tools will detect and respond to events that occur outside the root namespace. This CNRA functionality also has a technical benefit of improving visibility into non-root namespaces for purposes other than security, such as performance testing, usage accounting, lifecycle tracking, and debugging.

In some embodiments, determining the namespace in which the event occurred includes: identifying an event process in which the event occurred; finding a namespace creation process which created the namespace in which the event occurred, the namespace creation process being either the event process or an ancestor of the event process in a process hierarchy in the computing system; and determining the namespace from at least the namespace creation process.

Factoring in the namespace(s) as discussed herein for risk scoring presumes that a set of events is mapped to one or more namespaces in which the events occurred. This CNRA functionality has a technical benefit of improving security by providing a reliable, efficient, and portable mechanism which maps events to namespaces. Some embodiments described herein perform event-to-namespace mapping using a particular kind of map data structure taught herein.

In some embodiments, the ascertaining ascertains that the events occurred in different namespaces than each other, and the calculating calculates the risk score by at least one of: assessing a risk due to the events as though the events occurred in the same namespace as each other; assessing a risk due to the events as though the events were instigated by a same threat actor as each other; assessing a risk due to the events as though the events were coordinated with each other; or assessing a risk due to the events as though the events belong to a same attack as each other.

This CNRA functionality has a technical benefit of improving security by plugging a hole in risk assessment by factoring in the use of different namespaces to collectively perform a set of events. This hole is apparent in various example scenarios, in which the events of an attack are spread out to occur in different namespaces.

In one example scenario provided above, three different namespaces perform file listing, archive file creation, and archive file upload, respectively. Taken individually, these events are not unusual, and alerting on any one of them would often be treated as a false positive. But collectively, they match an exfiltration attack pattern which the CNRA functionality detects during risk assessment by factoring in the use of different namespaces to collectively perform the set of events. The attack pattern match is made in some embodiments by an attack pattern discriminator.

In another example scenario, a system permits only a limited number of certain actions from a new origin when that new origin is not recognized from historic data. After the limit is reached, further input from the new origin is blocked. Some attacks evade the limit by spreading the actions over multiple containers or other namespaces that provide multiple respective origins. Any single namespace stays below the limit, but the multiple namespaces as a group exceed the limit. Tools that treat namespaces as independent uncoordinated origins fail to detect and block the attack, whereas some CNRA-enhanced tools do detect and block the attack because they bundle together the actions from multiple namespaces.

In some embodiments, the ascertaining ascertains that the events occurred in different container namespaces than each other, and each container namespace corresponds to a respective container, each container including an application program and any code the application program is configured to invoke upon execution of the application program.

This CNRA functionality has a technical benefit of improving security in systems running containers. As discussed above and elsewhere herein, CNRA functionality plugs a hole in risk assessment by factoring in the events' namespaces, instead of considering only the events themselves. In particular, some CNRA embodiments factor in a use of different container namespaces when assessing risk.

In some embodiments, namespaces in the computing system are arranged in a namespace hierarchy, and the ascertaining includes locating a shared ancestor of the namespaces in the namespace hierarchy, the shared ancestor being a container namespace which corresponds to a container, the container including an application program and any code the application program is configured to invoke upon execution of the application program.

This CNRA functionality has a technical benefit of improving security in systems running containers by factoring in an indicator of container coordination when assessing risk. The presence of a shared ancestor of the namespaces (other than the root namespace, which is a shared ancestor of all namespaces in *nix systems) indicates a stronger likelihood that the namespaces sharing the ancestor are coordinated with one another. Accordingly, in some embodiments the events from those namespaces are treated as coordinated parts of a whole during risk assessment, instead of being treated as independent of one another. This improves security by permitting risk assessment to detect and mitigate attacks in which part of a kill chain is performed in one namespace and another part of the kill chain is performed in another namespace.

These and other advantages and benefits will be apparent to one of skill from the teachings provided herein.

### Operating Environments

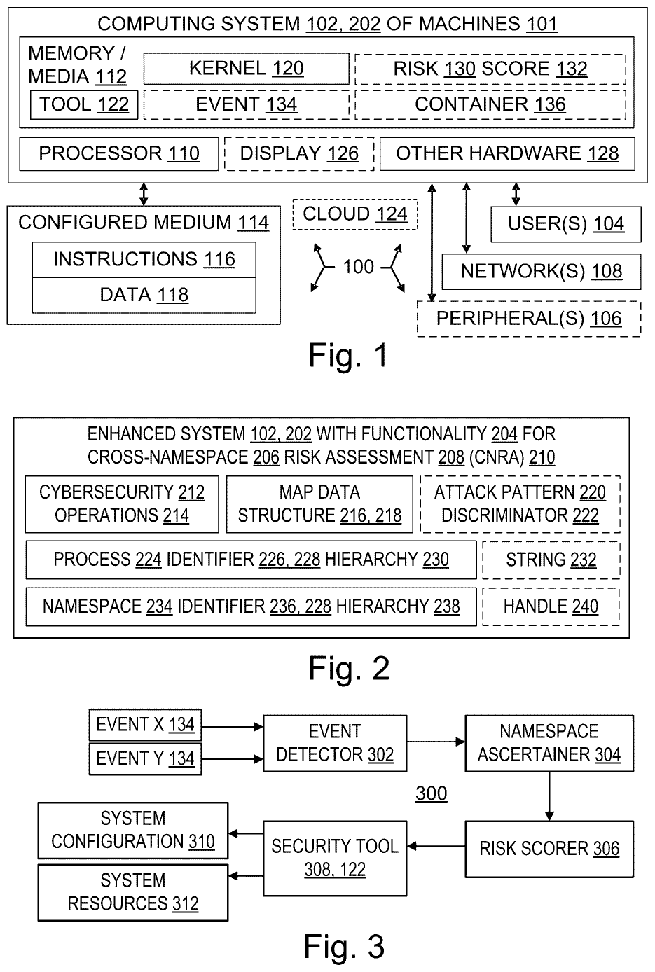

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Although for convenience, examples and claims herein sometimes speak in terms of accounts, “account” means “account or session or both” unless stated otherwise. In this disclosure, including in the claims and elsewhere, a statement about activity by “the user account or the user session” does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment 106 in some embodiments and part of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth.

Although an embodiment may include software instructions executed by one or more processors in a computing device (e.g., general purpose computer, server, or cluster), such description is not meant to exhaust all possible embodiments. Embodiments do not necessarily include any software. One of skill will also understand that the same or similar functionality of software can also often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments or operating environments, a system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected or only intermittently connected to another networked device or remote cloud. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not associated with a particular reference numeral herein. Corresponding drawings may also be added.

More about Systems

FIG. 2 illustrates a computing system 102 or other system configured by one or more of the CNRA functionality enhancements taught herein, resulting in an enhanced system 202. In some embodiments, an enhanced system 202 includes a single machine (computational or not), a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with CNRA functionality 204. In some embodiments consistent with FIG. 3, events 134 are detected 1102 by an event detector mechanism 302, such as a listener 1002 or a probe 1006, and passed to a namespace ascertainer 304. The namespace ascertainer 304 determines 1104 (identifies) the particular namespace(s) 234 where the events occurred. The namespace ascertainer 304 also ascertains 1106 how many namespaces there are corresponding to the events, and how those namespaces relate to one another, e.g., whether they share an ancestor 1016 other than a global root that is shared by all of the namespaces on the system. Such an ancestor is also referred to as a proper subroot.

These namespace characteristics 118 are passed to a risk scorer 306 which factors them into a risk score 132 calculation 1108. In some embodiments, when only a single namespace holds all the events in question, the risk score calculation is delegated to, or replicates the operation of, a familiar risk scoring mechanism that does not factor in namespace differences. But when the events occurred in multiple related namespaces, the risk score assesses risk 130 based on the events as a set despite their namespace diversity. In some proper subroot namespace scenarios, the risk scorer 306 increases the risk score beyond what it would have been had the events all occurred in a single namespace, to reflect the likelihood that the events were coordinated across those related namespaces by a threat actor 1018. In some scenarios, matching an attack pattern across multiple namespaces is scored as more risky than a coincidental presence of the events in the pattern.

Finally, the risk score 132 is passed to a security tool 308, 122, which performs operations 214 to efficiently and effectively protect the system resources 312 and the system configuration 310. When the risk score indicates an increased risk 130, some examples of suitable operations 214 include requiring additional authentication factors, blocking uploads, alerting security personnel, increasing the amount or granularity of logging, activating a honeypot, quarantining files, increased scanning for malware, changing permission settings, changing a role setting, disabling an account, and so on. When the risk score indicates a decreased risk 130, some security measures are reduced in some scenarios, to improve user satisfaction and productivity, and to reduce the use of system resources 312 such as network 108 bandwidth, processors 110, and storage 112.

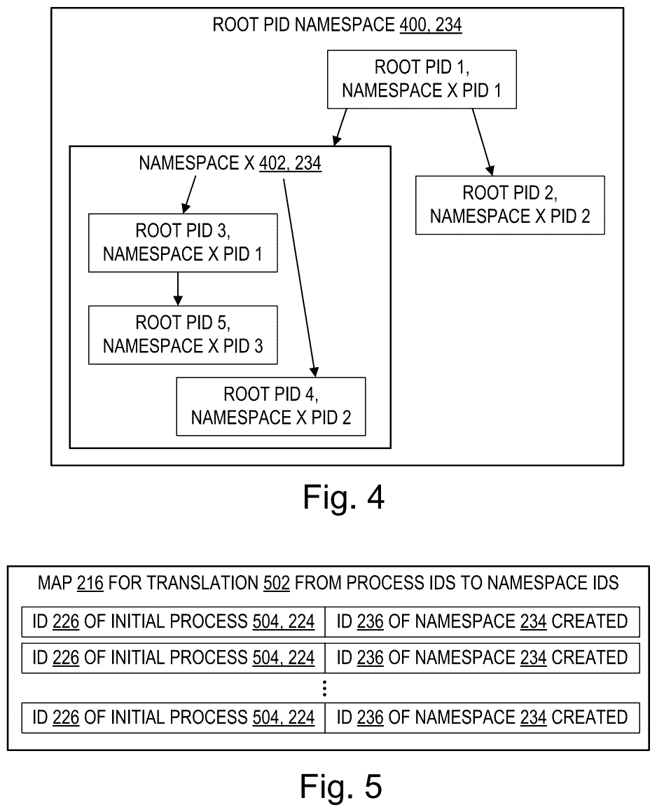

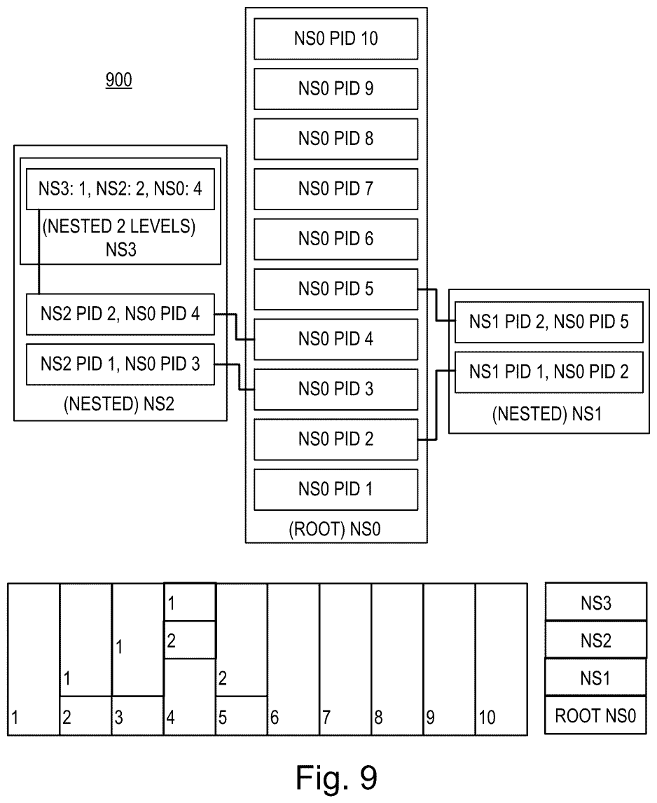

FIG. 4 is a diagram illustrating process identifiers and namespaces in a computing system. FIG. 4 shows a root PID (process identifier) namespace 400, 234 and a child namespace X 402, 234, each containing processes, which are represented in the figure by boxes reciting pids (process identifiers). A given process in the child namespace is identified within the child namespace by one pid and within the root namespace by another pid. As shown in FIG. 9, this use of multiple pids to identify the same process in multiple respective namespaces extends to three or more levels as namespaces are contained within (i.e., made descendants of) other namespaces. For instance, the first process in namespace X in FIG. 4 has namespace X pid 1 but has ancestor root namespace pid 3. In this example, a root namespace process identified by root pid 2 is visible to the child namespace X as namespace X pid 2.

As illustrated in FIG. 4, namespaces help partition or otherwise isolate system resources 312. Namespaces provide an abstraction that makes a group of processes operate as though they have their own dedicated instance of resources. By combining multiple namespaces, a container can be created with isolated views of the filesystem, process, network, and other resources 312, giving software in the container an illusion of running on a standalone machine. In this example, the PIDs inside a nested namespace all map 1-to-1 with PIDs in the root namespace. Thus, within the nested namespace, an application 1020 only sees PIDs 1 . . . n, but the root namespace sees all the processes.

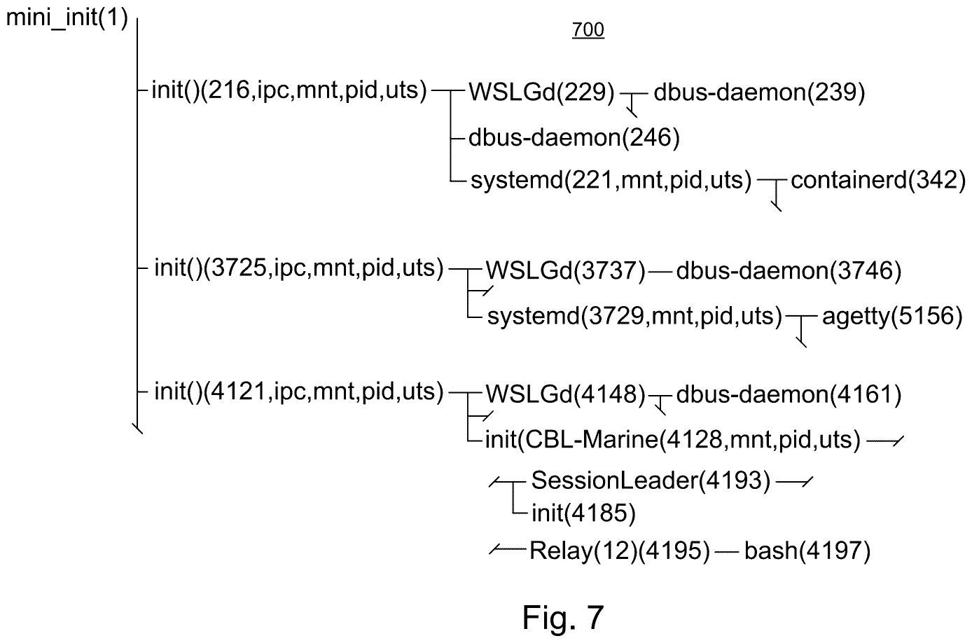

Many *nix environments support seven different types 1034 of namespaces 234 (Mount 1038, PID 1036, Network 1040, User 1046, IPC 1042, UTS 1044, CGroups 1048). Namespace types 1034 are also referred to as namespace kinds 1034. Variations on these type/kind names are also used; see, e.g., FIGS. 7, 8, and 10, wherein Mount is also designated as mnt, IPC is also designated as inter-process communication, UTS is also designated as time sharing, and CGroups is also designated as control group.

FIG. 5 is a block diagram illustrating a map data structure 216, 218 in a computing system which implements associations between process identifiers 226 and namespace identifiers 236. The initial process 504, 224 is the first process in a namespace, which is also the process that creates the namespace.

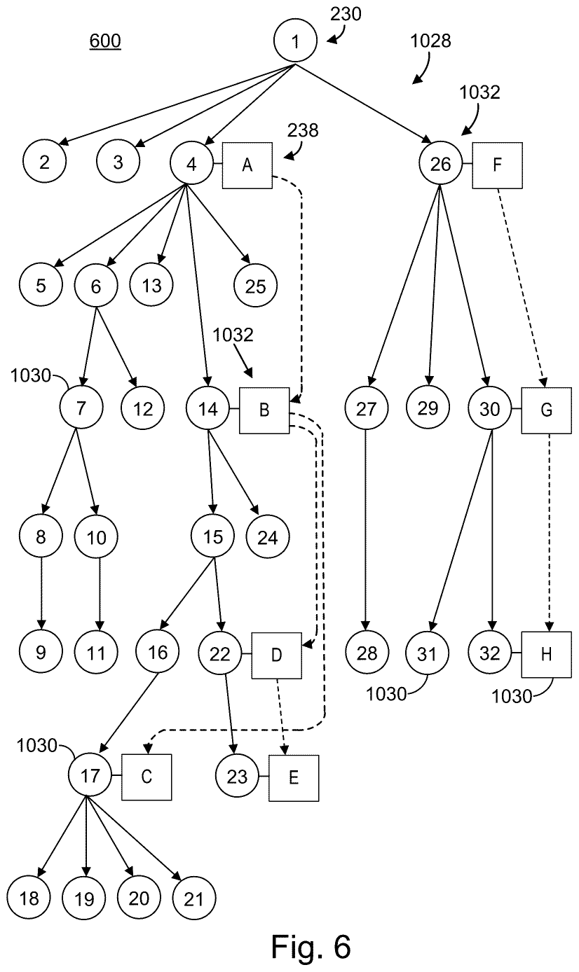

For instance, in the FIG. 6 diagram 600, the initial process of namespace A is process 4, the initial process of namespace B is process 14, the initial process of namespace C is process 17, and so on through to the initial process of namespace H which is process 32.

For clarity of illustration, FIG. 6 uses positive integers as process identifiers and uses letters as namespace identifiers, but identifiers 228 in an embodiment are numbers, letters, alphanumeric, indexes, pointers, hash values, or some combination of these or other values. Also, namespaces (as represented by namespace nodes 1030) are illustrated as labeled squares in FIG. 6, while processes (as represented by process nodes 1030) are illustrated as labeled circles in FIG. 6, but these shapes are for illustration purposes; they are not presented as implementation examples.

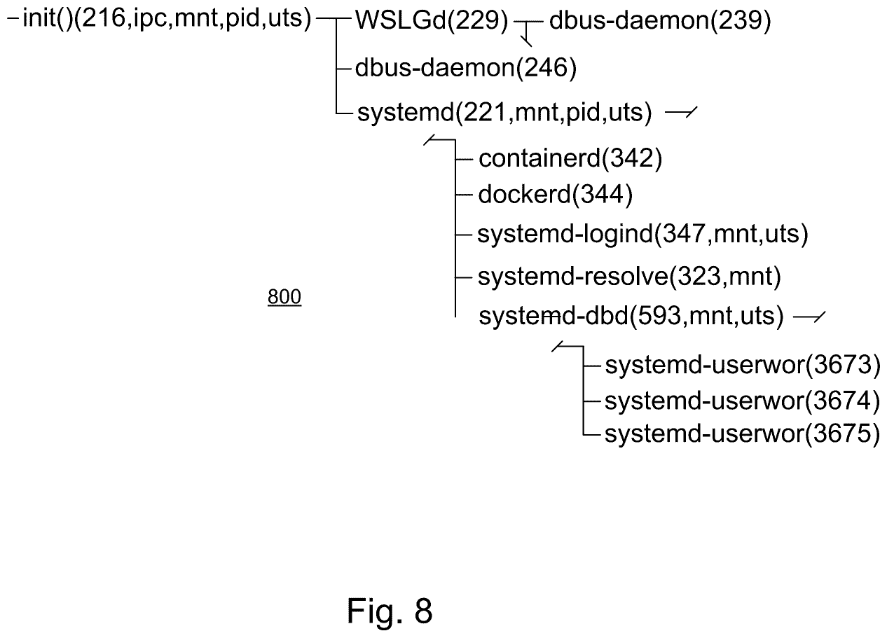

FIG. 6 is a view of one process hierarchy 230 and one associated namespace hierarchy 238 for one kind 1034 of namespace 234. For clarity of illustration additional namespace hierarchies are not shown in FIG. 6. However, the same process hierarchy 230 in some scenarios has one or more additional associated namespace hierarchies 238 for other kind(s) of namespaces. For instance, the process hierarchy illustrated in FIGS. 7 and 8 and denoted by pid in the list of namespaces created by process init 216 also has an associated ipc hierarchy 238, an associated mnt hierarchy 238, and an associated uts hierarchy 238, as indicated by the parenthetical list after the init process root namespace pid 216.

FIGS. 7 and 8 reproduce portions 700 and 800 of a process tree diagram which was generated by a pstree command in an example WSL™ environment. The full process tree is too large to reproduce here while still respecting brevity and complying with font size, margin, and other drawing requirements. In combination with skill in the art, the portions reproduced are sufficient to illustrate the aspects of trees 1028 discussed herein.

In FIGS. 7 and 8, initial processes 1014, 224 are shown with their root namespace pid and a parenthetical list of the namespace(s) the initial process creates. Initial processes are also referred to as namespace creation processes. For instance, in FIG. 7 an init process has root pid 216 and created ipc, mnt, pid, and uts namespaces. A descendant of process 216 shown in FIG. 7 is a systemd process, which has root namespace pid 221 and created mnt, pid, and uts namespaces. Thus, process systemd 221 has a mnt namespace that is nested in (i.e., a descendant of) the mnt namespace of process init 216. Process systemd 221 also has a pid namespace that is nested in the pid namespace of process init 216, and a uts namespace that is nested in the uts namespace of process init 216. Process systemd 221 did not create a new ipc namespace, so the ipc namespace of systemd 221 is the same ipc namespace as process dbus-daemon 246, WSLGd 229, dbus-daemon 239, and init 216 (which created that ipc namespace). The ipc namespace of containerd 342 is the same as the ipc namespace of systemd 221, because containerd 342 is a child of systemd 221 and containerd 342 did not create a new ipc namespace.

With further attention now to FIG. 5, in order to identify the namespace in which an event occurred, some embodiments find the pid of the process in which the event occurred, find the initial process that corresponds to that event occurrence process, and use the map 216 to identify the namespace in which the event occurred. For instance, in one scenario consistent with FIG. 6, an embodiment receives an event (not shown) from pid 28, correlates pid 28 to its ancestor namespace creation pid 26 in the process tree, and then maps pid 26 via the map 216 to namespace F.

FIG. 9 is a second relationship diagram 900 illustrating process identifiers, namespaces, and namespace identifiers in a computing system. NS stands for namespace. NS0 is the root namespace, NS1 is nested in NS0. NS2 is also nested in NS0, and NS3 is nested in NS2. Thus, in this namespace hierarchy, NS2 is an ancestor of NS3, NS0 is an ancestor of NS2 and also an ancestor of NS1, and NS0 is the root of the hierarchy, i.e., the root of the tree containing all namespaces on the system.

In some embodiments, a namespace relationship is derived from a parent process. If two processes in different namespaces bubble up (via tree traversal, e.g., in a tree like one shown in FIG. 6, or one shown in FIGS. 7 and 8) into a common process 1016 in a different namespace, the embodiment considers the two namespaces to be descendants of that ancestor.

Some embodiments establish a nesting relationship between namespaces and collapse all nested namespaces to a container root namespace 402 that has an identity 236. This collapsing does not alter the actual hierarchy in the system, but rather groups namespaces together for purposes such as event detection and malware protection. This enables the embodiment to ensure that threat actors cannot break detection by running then in separate namespaces, because all activities inside different namespaces in a container will be flattened and treated as a set at the container boundary. This functionality also provides a better container experience for the end-user.

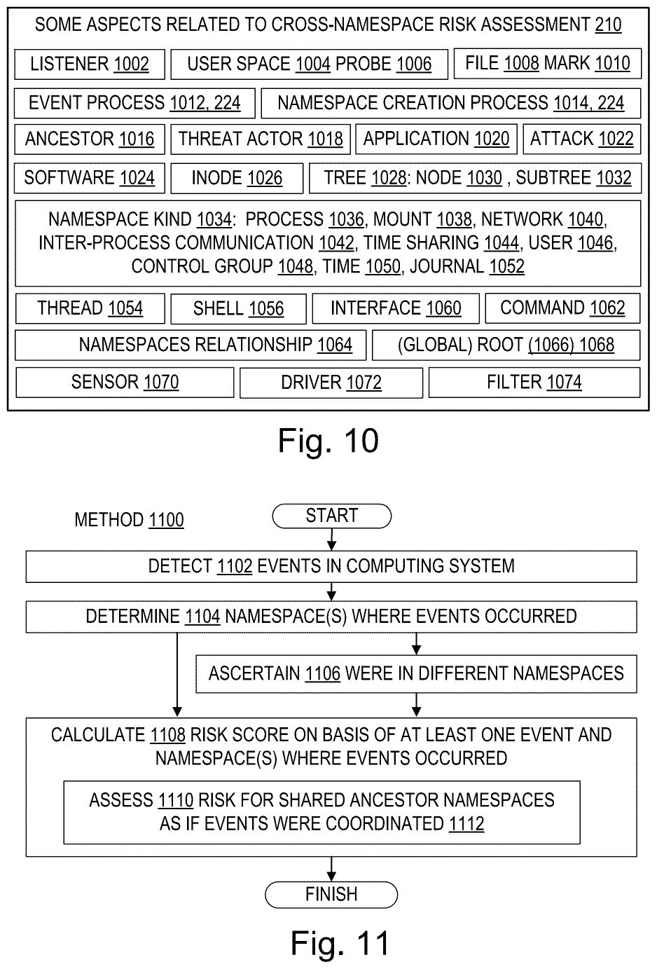

FIG. 10 is a block diagram of some mechanisms, data structures, contextual items, characteristics, and other aspects of cross-namespace risk assessment in some enhanced systems. FIG. 10 items are discussed at various points in the present disclosure.

FIGS. 1-10 do not individually or collectively or in any subset fully define a comprehensive summary of all aspects of enhanced systems 202 or all aspects of CNRA functionality 204. Nor is any figure of FIGS. 1-10 or any group of figures of FIGS. 1-10 by itself a comprehensive summary of all aspects of an environment 100 or another context of an enhanced system 202.

The other figures are also relevant to systems 202. FIGS. 11 to 13 are flowcharts which illustrate some methods of CNRA functionality 204 operation in some systems 202.

In some embodiments, the enhanced system 202 is networked through an interface 1060. In some, an interface 1060 includes hardware such as network interface cards, software such as network stacks, APIs, or sockets, combination items such as network connections, or a combination thereof.

Some embodiments include a computing system 202 which is equipped, structured, or otherwise configured to utilize or provide CNRA functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101, but “memory” without set also includes systems with multiple memories. Similarly, the phrase “processor set” is used to emphasize that a processor 110 is not necessarily confined to a single chip or a single machine 101, but “processor” without set also includes systems with multiple processors.

All sets herein are non-empty unless described otherwise. Any set identified in this description is empty, or is non-empty, depending on the embodiment and the circumstances. However, even an empty set is defined and detectable in the system 202 as a set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 including: a digital memory 112; a processor 110 in operable communication with the digital memory; a map data structure 216 residing in the digital memory, the map data structure including an association of namespace identifiers 236 with corresponding process identifiers 226; and a set of instructions 116 which is not empty, the set of instructions representing a sequence of cybersecurity steps, which upon execution by the processor: detect 1102 at least two events 134 in the computing system, for each event in a non-empty set of events which includes the at least two events identify 1310 a respective event process 1012, 224 in which the event occurred, determine 1104 for each event through use of at least the map data structure a namespace 234 in which the event occurred, ascertain 1106 whether the events in the non-empty set of events occurred in different namespaces than each other, calculate 1108 a risk score 132 from at least the at least two events and from at least a result of the ascertaining, and perform 1202 a cybersecurity operation 214 according to at least the risk score.

In some embodiments, a process identifier 226 in the map data structure 216 identifies a namespace creation process 1014 which created the namespace identified by the associated namespace identifier, the sequence of cybersecurity steps includes matching 1316 the event process to the namespace creation process, and the namespace creation process is either the event process or an ancestor 1016 of the event process in a process hierarchy 230 in the computing system.

In one example consistent with FIG. 6, an event occurred in the process 16. A process identifier in the map data structure identifies a namespace creation process 14 which created a namespace identified by the associated namespace identifier B, the sequence of cybersecurity steps includes matching the event process 16 to the namespace creation process 14, and the namespace creation process is an ancestor of the event process in the process hierarchy.

In another example consistent with FIG. 6, an event occurred in the process 14. The process identifier in the map data structure identifies the namespace creation process 14 which created the namespace identified by the associated namespace identifier B, the sequence of cybersecurity steps includes matching the event process 14 to itself as the namespace creation process 14, and the namespace creation process is the event process in the process hierarchy 230 in the computing system.

In some embodiments, the process hierarchy 230 has a single global root 400 which is an ancestor 1016 of all processes 224 in the computing system, and the namespace creation process 1014 is positioned in the process hierarchy below the global root of the process hierarchy. For example, *nix environments often have a single global root 400 which is an ancestor 1016 of all processes 224 in the environment, whereas Windows systems typically do not. In particular, in some Linux systems /proc/[PID]/root is the storage root. Most if not all files 1008, directories, and devices on the Linux system are nested within this tree structure, starting from /. PID is a process identifier, which is assigned by a Linux system when a process starts. Each process is identified by a unique process identifier which may be recycled on process termination. Some embodiments translate PID in the namespace to PID in root namespace. By contrast, in Windows systems, storage is accessible as drives C:\, D:\, etc.

Some embodiments include an attack pattern discriminator 222. In some of these, the computing system ascertains 1106 that the events occurred in different namespaces 234 than each other, and the computing system submits 1318 the events together to the attack pattern discriminator, e.g., via an API or a shared portion of memory 112.

In some embodiments, the attack pattern discriminator 222 checks whether a set of events includes or otherwise matches an attack pattern 220. A kill chain is an example of an attack pattern. Some other examples of attack patterns include: an authentication with a compromised credential followed by creation of a new user account, a risky user alert with an access elevation alert and a resource quota increase and a virtual machine creation, a risky user alert and a guest invitation alert followed by a high privilege role assignment on the guest user, the file listing-archive creation-upload pattern above and other patterns noted elsewhere in this disclosure, and patterns which are identified in a framework such as the MITRE ATT&CK® model (mark of The MITRE Corporation), the CYBER KILL CHAIN® model (mark of Lockheed Martin Corporation), or the STRIDE™ threat model (mark of Microsoft Corporation).

In some embodiments, each event process 1012 is in a process hierarchy 230 in the computing system which includes a process tree 1028 of process nodes 1030 which represent processes 224, each namespace 234 is in a namespace hierarchy 238 in the computing system which includes a namespace tree 1028 of namespace nodes 1030 which represent namespaces 234, the namespace tree corresponds to a proper subtree 1032 of the process tree, and the sequence of cybersecurity steps matches two process nodes to a same namespace node which corresponds to a shared ancestor 1016 of the two process nodes.

For example, in FIG. 6 the namespace tree A=>B=>C, (D=>E) corresponds to a proper process subtree rooted at process 4, and the namespace tree F=>G=>H corresponds to a proper process subtree rooted at process 26. In one scenario, the sequence of cybersecurity steps matches process nodes 15 and 24 to the same namespace node B which corresponds to a shared ancestor of the two process nodes 15 and 24. In another scenario, the sequence of cybersecurity steps matches process nodes 15 and 16 to the same namespace node B which corresponds to a shared ancestor of the two process nodes 15 and 16.

In some embodiments, each namespace 234 in which a detected event 134 occurred is identified 1320 by an inode number 1026. For example, most if not all *nix environments identify namespaces using inode numbers, whereas Windows environments do not typically use inode numbers.

In some embodiments and scenarios, the detected events 134 occurred in different namespaces 234 than each other, and each namespace in which a detected event occurred includes a respective container 136 namespace 234 which corresponds to a respective container 136. For example, in one scenario consistent with FIG. 9, NS1, NS2, and NS3 are respective container namespaces.

In some embodiments and scenarios, the namespace 234 in which the event occurred includes at least one of: a process 1036 namespace, a mount 1038 namespace, a network 1040 namespace, an inter-process communication 1042 namespace, a time sharing 1044 namespace, a user 1046 namespace, a control group 1048 namespace, a time 1050 namespace, or a journal 1052 namespace.

In some embodiments, a process 1036 namespace creates an isolated view of system resources for a set of processes 224. In some embodiments, a mount 1038 namespace provides processes with a unique view of a file system hierarchy. In some embodiments, a network 1040 namespace isolates network stacks. In some embodiments, an inter-process communication 1042 namespace isolates processes from each other with regard to communication mechanisms such as shared memory, semaphores, and message queues. In some embodiments, a time sharing 1044 namespace (also called a UNIX® Time-Sharing or UTS namespace (UNIX is a registered mark of X/Open Company Ltd.)) allows a system to appear to have different hostnames and domain names to different processes. In some embodiments, a user 1046 namespace maps users in a container to different users in a host. In some embodiments, a control group 1048 namespace allows isolation and management of system resources by creating separate views of control groups for different sets of processes. In some embodiments, a time 1050 namespace allows per-namespace offsets to a system's clocks. In some embodiments, a journal 1052 namespace allows separation and categorization of log messages from different parts of a system.

Other system embodiments are also described herein, either directly or derivable as system versions of described processes or configured media, duly informed by the extensive discussion herein of computing hardware.

Although specific CNRA architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of CNRA functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

### Processes (a.k.a. Methods)

Processes (which are also referred to as “methods” in the legal sense of that word) are illustrated in various ways herein, both in text and in drawing figures. FIGS. 11 to 13 each illustrate a family of methods 1100, 1200, and 1300 respectively, which are performed or assisted by some enhanced systems, such as some systems 202 or another functionality enhanced system as taught herein. Method family 1100 and method family 1200 are each a proper subset of method family 1300. Moreover, activities are identified in FIGS. 1 to 10 as explicit or implicit method steps are likewise incorporated into method 1300, e.g., creating a process 224, creating a namespace 234, creating a container 136, executing a process, executing code 1024 in a container, terminating a process, terminating a container, launching a shell (e.g., bash) 1056, executing a command 1062 in a shell, terminating a shell, and so on. Also, steps that are not expressly tied herein to a particular reference number are not thereby excluded from method 1300. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types text into a shell 1056. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 13. FIG. 13 is a supplemental portion of the textual and figure drawing examples of embodiments provided herein and the descriptions of embodiments provided herein. In the event of any alleged inconsistency, lack of clarity, or excessive breadth due to an interpretation of FIG. 13, the content of this disclosure shall prevail over that interpretation of FIG. 13.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1300 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 13 to be non-operable, the sequence S is not within the scope of any claim. Any assertion otherwise is contrary to the present disclosure.

Some embodiments provide or utilize a cybersecurity method 1300 which is performed by a computing system. The method includes: detecting 1102 at least two events 134 in the computing system; for each event in a non-empty set of events which includes the at least two detected events, determining 1104 a namespace 234 in which the event occurred; ascertaining whether the events in the non-empty set of events occurred in different namespaces than each other; calculating 1108 a risk score 132 from at least one of the events in the non-empty set of events and from at least a result of the ascertaining; and performing 1202 a cybersecurity operation 214 according to at least the risk score.

In some embodiments, namespaces 234 in the computing system are arranged in a namespace hierarchy 238 which includes a root namespace 400 and at least one non-root namespace 402; the at least two events 134 occurred outside the root namespace; and the detecting 1102 includes receiving 1302, 1304 the at least two events in the root namespace.

In some embodiments, the detecting 1102 includes at least one of: receiving 1306, 1304 a filesystem activity event 134 through a fanotify listener 1002; receiving 1306, 1304 a filesystem activity event through an inotify listener 1002; receiving 1306, 1304 an event from a Berkeley Packet Filter (BPF) sensor 1070, 1074; receiving 1306, 1304 an event from a sensor 1070; receiving 1308, 1304 an event from a driver 1072; or 1308, 1304 receiving an event 134 from a user space 1004 probe 1006 which is in a container 136. Some embodiments add uprobes on a libpam library in each container of interest, which generates callbacks when a user authentication function is called, for example. Some attach a BPF program 1074 to read called function parameter values and to collect information. In FIG. 11, listeners 1002, sensors 1070, and filters 1074 are grouped together under receiving 1306, and probes 1006 and drivers 1072 are grouped together under receiving 1308, for convenience of illustration, not to indicate any particular similarity or difference in items 1002, 1006, 1070, 1072, and 1074, or in their operations when receiving 1304 events.

In some embodiments, determining 1104 the namespace 234 in which the event 134 occurred includes: identifying 1310 an event process 1012, 224 in which the event occurred; finding 1312 a namespace creation process 1014, 224 which created the namespace 234 in which the event occurred, the namespace creation process being either the event process or an ancestor 1016 of the event process in a process hierarchy 230 in the computing system; and determining 1104 the namespace from at least the namespace creation process.

In some embodiments and scenarios, the ascertaining ascertains 1106 that the events in the non-empty set of events occurred in different namespaces than each other, and the calculating calculates 1108 the risk score 132 by at least one of: assessing 1110 a risk 130 due to the events as though the events occurred in the same namespace 234 as each other; assessing 1110 a risk 130 due to the events as though the events were instigated by a same threat actor 1018 as each other; assessing 1110 a risk 130 due to the events as though the events were coordinated 1112 with each other; or assessing 1110 a risk 130 due to the events as though the events belong to a same attack 1022 as each other.

In some embodiments and scenarios, the ascertaining ascertains 1106 that the events in the non-empty set of events occurred in different container namespaces 234 than each other, and each container namespace corresponds to a respective container 136, each container including an application program 1020, 1024 and any code 1024 the application program is configured to invoke upon execution of the application program.

In some embodiments, namespaces 234 in the computing system are arranged in a namespace hierarchy 238, and the ascertaining 1106 includes locating 1314 a shared ancestor 1016 of the namespaces in the namespace hierarchy, the shared ancestor being a container namespace 234 which corresponds to a container 136, the container including an application program 1020, 1024 and any code 1024 the application program is configured to invoke upon execution of the application program.

### Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing CNRA functionality 204 as disclosed herein. The Figures thus help illustrate configured storage media embodiments and process (a.k.a. method) embodiments, as well as system and process embodiments. In particular, any of the method steps illustrated in FIGS. 11 to 13, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a cybersecurity method 1300. This method 1300 includes: detecting 1102 at least two events in the computing system; for each event in a non-empty set of events including those detected events, determining 1104 a namespace in which the event occurred; ascertaining 1106 that the events in the non-empty set of events occurred in different namespaces than each other; calculating 1108 a risk score from at least the at least two events; and performing 1202 a cybersecurity operation according to at least the risk score.

Some embodiments include injecting 1322 a thread 1054 which is configured to upon execution acquire 1324 a handle 240, and the detecting 1102 includes detecting 1102 at least one event 134 via the handle. In some embodiments, the injected thread places a FANOTIFY mark 1010 and shares the file descriptor with a fanotify monitor running in the root namespace. The handle received from the fanotify mark is a handle to a file 1008 and is used to receive events. Since the injected thread exits after marking and relaying back the file descriptor, within the monitored (thread-injected) namespace itself there is no trace of being monitored.

Some embodiments include mapping 502 a process identifier 226 to a namespace identifier 236 which identifies the namespace 234 in which at least one of the events occurred.

Some embodiments include generating 1326 a string 232 “/proc/[pid]/ns/pid” in which [pid] is an identifier 226 of a process in which at least one of the events occurred, and utilizing 1328 the string to determine 1104 the namespace in which the event occurred. In this embodiment, determination 1104 makes use 1328 of the string; the string is not necessarily the only item determination 1104 uses 1328 to determine 1104 the namespace.

For example, to access /etc/passwd inside a given pid namespace, some embodiments utilize /proc/[PID]/root/etc/passwd, e.g., within the namespace created by process 3725 of FIG. 7, an access string /proc/3725/root/etc/passwd is used.

In another illustration of screenshots of utilizing strings, running a Linux top command in a nested namespace yields a PID is reported as 348:
userfoo [˜]$ ps faux | grep top | grep −v grep
userfoo 348 0.2 0.0 6180 4532 pts/2 S+ 13:43 0:00 |
userfoo [˜]$ Is −al /proc/348/ns/pid
Irwxrwxrwx 1 userfoo userfoo 0 Nov 15 13:44/proc/348/ns/pid -> ‘pid: [4026532255]’

The PID is reported as 738 in the root namespace. But both resolve to report the same PID namespace (although this implementation recites “pid: [4026532255]” in fact 4026532255 is a namespace identifier:
root@hostfoo [˜]#ps faux | grep top | grep −v grep wslg 738 0.2 0.0 6180 4532? S+ 08:43 0:00 | | |
root@hostfoo [˜]#Is −al /proc/738/ns/pid
Irwxrwxrwx 1 wslg wslg 0 Nov 15 08:15/proc/738/ns/pid-> ‘pid: [4026532255]’

In some *nix environments, an embodiment can access a root namespace with any PID, e.g., pid 1 which is init, the first process. For example, an embodiment can use /proc/1/root to access the file system, which is also accessible directly as /, or /proc/1/ns/pid-> ‘pid:[4026531836]’. The namespace identifier 4026531836 is a constant namespace ID for the root namespace in many *nix systems, including many Linux systems.

Some embodiments listen to system activity through sensors to get the PID information that is used to determine the namespace ID. An activity (one or more events) is associated with a process. The embodiment extracts namespace information from /proc/[PID]/ns/pid. The embodiment maintains a map 216 where it stores namespace ID 236 and the PID of the first process 504 of that namespace. The first process 504 will exit last from the namespace, and with that exit the namespace will terminate. The embodiment uses that PID for further operations, such as accessing a container filesystem as /proc/[INIT_PID]/root.

For example, in some scenarios when an event is received, the embodiment has the NSID (namespace id, which is basically an INODE number) from /proc/[PID]/ns/pid and uses the init-pid of the first process 504 to access /proc/[PID]/root. The process can be short lived, so that by the time the embodiment accesses/proc the process may have terminated. But the first process is last to exit and the namespace will be terminated with it, so the embodiment uses the init-pid of the first process 504 in the mapping 502.

In one example, and with attention to FIG. 8, when an ipc event occurs in system-userwor 3673, instead of process 3673 the map includes ancestor process 216 which created the ipc namespace of process 3673. In placing a fanotify mark 1010, the embodiment marks process 216 instead of process 3673. As another example, process 3673 has the same mnt namespace as process 593 so process 3673 and process 593 each have the same visibility to the other's events, and instead of marking 3673 an embodiment marks 593.

In some embodiments, each of the different namespaces is the namespace 234 of a respective container 136, and at least one of: the respective containers are each nested within a third container; or one of the respective containers is nested within another of the respective containers. For example, in one scenario a container namespace NS5 and a container namespace NS6 are each nested with a container namespace NS4.

In some embodiments and scenarios, a namespace is a Linux internal construct identified with a unique inode number that is allocated when the namespace is created. In some, 4026531836 is the only persistent identifier for a root namespace, and in some zero is reserved as the root namespace identifier.

In some embodiments and scenarios, a container is a construct of container manager software, which creates an isolated environment to run applications. Some container manager software creates namespaces using internal identifiers that have little semantic content for humans, but also provide a persistent friendly namespace name or container name to human users. Internally within the system's software, these containers are identified by a GUID (WSL) or a hex string (Docker), for example. These friendly names are referred to as identifiers and have unique internal representations across installations, despite having the same name.

In some systems, different types of containers or other virtualizations can be run side-by-side on the same device. They may or may not share an underlying operating system or kernel. In some systems, a shared root exists for at least some virtual machines. A root hypervisor runs in a privileged Domain 0 (Dom0) while the virtual machines run in an unprivileged guest Domain (DomUs) and with nested virtualization, a hierarchy is Host (Dom0)=>First-level Guest (DomU)=>Nested Guest Domains (Nested DomUs). With virtual machines, the information to inspect and block activity is not directly accessible to host/root/Dom0. In some such scenarios, an implementation injects a guest component that opens a privileged channel with the component in the host and shares event and identification information.

In some embodiments, the cybersecurity method 1300 includes: detecting 1102 a first event 134 in the computing system; detecting 1102 a second event 134 in the computing system, the second event different than the first event; determining 1104 a first namespace 234 in which the first event occurred; determining 1104 a second namespace 234 in which the second event occurred; ascertaining 1106 that the first namespace and the second namespace are different namespaces 234 than each other; calculating 1108 a risk score 132 from at least the first event and the second event; and performing 1202 a cybersecurity operation 214 according to at least the risk score.

In some embodiments, the method 1300 includes injecting 1322 a thread which is configured to upon execution acquire a handle, and the detecting includes detecting at least one of the first event or the second event via the handle.

In some embodiments, the method 1300 includes mapping a process identifier to a namespace identifier which identifies the namespace in which at least one of the first event 134 or the second event 134 occurred.

In some embodiments, the method 1300 includes generating 1326 a string “/proc/[pid]/ns/pid” in which [pid] is an identifier of a process in which at least one of the first event 134 or the second event 134 occurred, and utilizing 1328 the string to determine the namespace in which said event (i.e., at least one of the first event 134 or the second event 134) occurred.

### Additional Observations

Support for the discussion of CNRA functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

Some embodiments use the process namespace paths (specifically ‘/proc/[PID]/ns/pid’) to monitor the start and stop events of containers without relying on the container management software. By comparing the namespace paths of different processes, an embodiment finds the first process of each container. Some embodiments also detect the exit of containers by observing the end of the init process. This method ensures that the container state information is always current and matches the actual state of the system. This method works for different namespace types, such as pid, mnt, ipc, and others, providing a flexible solution.

When a process starts, an embodiment retrieves the process namespace from ‘/proc/[PID]/ns/pid’. The process ID (PID) and namespace id are added to a map 216 if they do not exist in the map. On a process exit event, the system checks if the PID is present in the map. If present, the entry is removed, ensuring that the first process in a namespace, which is also the last to exit, is accurately tracked.

Some embodiments include an Event Monitor module that listens for process start and exit events, a Namespace Map data structure 216 that maintains a mapping between namespaces and their associated init processes, and a Namespace Retriever utility that retrieves the namespace information of a process from ‘/proc/[PID]/ns/pid’. The embodiment initializes the Namespace Map as an empty data structure to store namespace and process mappings along with any other metadata. Upon detecting a process start event, the Event Monitor triggers the Namespace Retriever. The Namespace Retriever accesses ‘/proc/[PID]/ns/pid’ to obtain the namespace of the process.

In operation, this embodiment checks whether the namespace is already present in the Namespace Map. If not, the embodiment adds an entry with the namespace and the PID. If the namespace is already in the map, no action is taken to update the map. On a process exit event, the Event Monitor identifies the exiting process. The embodiment checks whether the exiting process PID is listed in the Namespace Map. If present, the entry for the namespace is removed from the map. If not, no action is taken to update the map, as the exiting process is not an init process 504.

One benefit is that by using namespace paths, the method is applicable to a broader range of container types, including pid, mnt, ipc, and others, rather than being limited to cgroups, for example. The method also ensures that the first process in a namespace, which is also the last to exit, is accurately tracked, reducing the risk of errors in container lifecycle management. The use of namespace paths also simplifies the process of identifying and managing container start and stop events, reducing the complexity of implementation.

In some scenarios, sensors can effectively receive user login events by attaching probes to a libpam library. With BPF programs, an event monitor can intercept and extract the function arguments to find the user information and other related information. However, containers can complicate this monitoring due to their ability to overlay different filesystems, potentially overriding the libpam library in the root partition.

Some embodiments provide or utilize a method for monitoring user authentication events in containers, ensuring accurate detection even when containers overlay different filesystems. This is achieved by: detecting the creation of new namespaces, attaching user probes to the libpam library within the container's internal filesystem path, identifying and adding probes to already existing namespaces, and removing probes when namespaces are terminated.

Some embodiments include a Namespace Monitor which detects the creation and termination of namespaces, a Probe Manager which manages the attachment and detachment of user probes, a Process Iterator which iterates over existing processes to find and monitor namespaces, and an Authentication Event Sensor which receives and processes user login events.

In operation, this embodiment initializes the Namespace Monitor, Probe Manager, and Process Iterator. The Authentication Event Sensor is set up to monitor user probes with BPF. The Namespace Monitor detects new namespace creation events. For each new namespace, the Probe Manager accesses the container's internal path via/proc/[PID]/root and attaches a BPF program to user probe to the libpam library. During system initialization, the Process Iterator iterates over all existing processes. For each process, it checks for namespace creation and adds probes to processes to be monitored. The Namespace Monitor detects namespace termination events. The Probe Manager removes the corresponding BPF program and probes.

One benefit is that the method dynamically adds and removes probes based on namespace events, ensuring accurate monitoring. By accessing container internal paths via /proc/[PID]/root, the method also handles filesystem overlays effectively. The method also covers both new and existing namespaces, providing comprehensive monitoring.

Some embodiments monitor filesystem activity in containerized environments by leveraging FANOTIFY. One method involves detecting the creation of namespaces and applying FANOTIFY marks on the container filesystem by accessing it through the /proc/[PID]/root path. This approach enables the FANOTIFY listener to receive filesystem activity from the namespace, allowing anti-malware software to monitor and potentially block unauthorized file operations within containers.

In operation, this embodiment detects the creation of new namespaces within the operating system, e.g., by tracking system calls related to namespace creation. Upon detecting a new namespace, the embodiment identifies the initial process ID (PID) of the namespace. This PID is used to construct the path to the container's root filesystem, /proc/[PID]/root. The embodiment applies a FANOTIFY mark on the container's root file system using the path /proc/[PID]/root. This mark enables a FANOTIFY listener to receive filesystem activity events from within the container. The FANOTIFY listener starts receiving events related to filesystem activity within the container. The security software analyzes these events to detect and potentially block unauthorized file operations. To resolve file paths within the container, the embodiment adds the /proc/[PID]/root prefix to the relevant paths. This allows the security software to correctly interpret and act upon the filesystem activity within the container. For reliability in non-blocking mode, where the initiating process is sometimes short-lived, the embodiment maintains a map of initial process IDs for each namespace. This ensures that the correct path resolution is maintained throughout the lifecycle of the container.

One benefit is that by monitoring filesystem activity within containers, the security software is able to detect and prevent unauthorized file operations that go unnoticed in other monitoring setups. The method is also well designed to handle the complexities introduced by containerized environments and nested namespaces. The embodiment also ensures reliability even in non-blocking mode by maintaining a map of initial process IDs, preventing disruptions caused by short-lived processes.

Some embodiments converge all system activity within nested namespaces into a common container boundary, simplifying management and monitoring tasks. Some embodiments collapse nested namespaces into a container root namespace, as identified by the container management software. When a container is created, the container management software provides a container identifier. This identifier, along with the namespace identifier and initial PID, is saved in the map 216. When a new nested namespace is created, the embodiment retrieves the parent process PID's namespace ID from /proc/[PPID]/ns/pid. An entry is created in the map with the new namespace identifier, initial process identifier (PID), and the container identifier copied from the parent process namespace entry. The map is updated dynamically to reflect the current state of namespaces, ensuring that all nested namespaces in a container share the same container identifier.

Some embodiments include an Event Monitor module that listens for namespace creation events, a Namespace Map data structure that maintains a mapping between namespaces, initial PIDs, and container identifiers, a Namespace Retriever utility that retrieves namespace information from /proc/[PID]/ns/pid and /proc/[PPID]/ns/pid, and a Container Management Interface container management software API to supply container identifiers.

In operation, the embodiment initializes the Namespace Map as an empty data structure to store namespace, initial PID, and container identifier mappings along with any other metadata. Upon container creation, the Container Management Interface provides a container identifier. The embodiment retrieves the namespace identifier and initial process PID of the container's initial process, if not already provided by the Container Management Software. An entry is added to the Namespace Map with the namespace identifier, initial process PID, and container identifier. Upon detecting a nested namespace creation event, the Event Monitor triggers the Namespace Retriever. The Namespace Retriever accesses /proc/[PPID]/ns/pid to obtain the parent process's namespace ID. The embodiment checks the Namespace Map to retrieve the container identifier associated with the parent process's namespace. An entry is created in the Namespace Map with the new namespace, initial process PID, and the container identifier copied from the parent process's namespace entry. The Namespace Map is dynamically updated to ensure all nested namespaces have the same container identifier, enabling efficient management of system activity within the container boundary.

One benefit is that the method simplifies the management and monitoring of containerized applications by collapsing nested namespaces into a common container root namespace boundary. Also, by converging system activity from nested namespaces into a common container boundary, the embodiment improves observability and control over containerized environments. The method also integrates seamlessly with existing container management software, leveraging standard namespace and process information.

Some embodiments provide or utilize a computer security method performed by a computing system, the method including: locating at least two namespaces; detecting an event in each namespace; determining that the namespaces share the same root; identifying a risk based on the events and the shared root; and taking action to mitigate the risk.

Some embodiments provide or utilize a cybersecurity method performed by a computing system, the method including: detecting at least two events in the computing system; determining a non-empty namespace set which includes each namespace in which at least one of the at least two events occurred; ascertaining whether the namespace set has more than one subtree root namespace; calculating a risk score from at least a result of the ascertaining; and performing a cybersecurity operation according to at least the risk score. A subtree root namespace is not the root of an entire namespace tree in a system, e.g., not the root of the global pid or mnt or ipc namespace tree of the system.

In some scenarios, two namespaces have the same subtree root namespace, e.g., the same container root namespace. In some embodiments, the determining determines that an event A of the at least two events occurred in a namespace X, and determines that an event B of the at least two events occurred in a namespace Y; the namespace set contains the namespace X and the namespace set also contains the namespace Y; the ascertaining ascertains that the namespace set has a subtree root namespace R, wherein R is the subtree root namespace of namespace X, and R is also the subtree root namespace of namespace Y; the calculating calculates the risk score from at least a result of the ascertaining by treating event A and event B as events that belong to a same namespace as each other; and the performing performs the cybersecurity operation according to at least the risk score, event A, and event B.

In some scenarios, two namespaces have different respective subtree root namespaces. In some embodiments, the determining determines that an event A of the at least two events occurred in a namespace X, and determines that an event B of the at least two events occurred in a namespace Y; the namespace set contains the namespace X and the namespace set also contains the namespace Y; the ascertaining ascertains that the namespace set has a subtree root namespace R and also has a subtree root namespace S, wherein R is the subtree root namespace of namespace X, and S is the subtree root namespace of namespace Y; and the calculating calculates the risk score from at least a result of the ascertaining by treating event A and event B as events that belong to unrelated namespaces.

In some scenarios, events pose a greater risk when they have a container root namespace in common. In some embodiments, the method is repeated such that: a first ascertaining ascertains that a first namespace set has only one container root namespace; a first calculating calculates a first risk score from at least a first result of the first ascertaining; a second ascertaining ascertains that a second namespace set has more than one container root namespace; a second calculating calculates a second risk score from at least a second result of the second ascertaining; and the first risk score represents a greater risk than the second risk score.

In some scenarios, containers are nested. In some embodiments, the determining determines that a first event of the at least two events occurred in a first namespace of a first container; the determining determines that a second event of the at least two events occurred in a second namespace of a second container; the first container and the second container are each nested within a third container; the third container has a third container root namespace; the ascertaining ascertains that the third container root namespace is a container root namespace of the first namespace; and the ascertaining also ascertains that the third container root namespace is a container root namespace of the second namespace.

Some embodiments use paths in namespace identifiers when checking for a shared subtree root namespace. The paths can be read or inferred from a namespace map data structure. In some embodiments, ascertaining whether the namespace set has more than one subtree root namespace includes: for each namespace in the namespace set, locating a path in a non-empty set of namespace paths, each located path identifying a respective namespace; and checking whether two located paths share a sub-path which identifies a shared subtree root namespace.

In some embodiments, a non-empty set of namespace paths resides in a namespace map data structure, and the method includes: detecting a start event which starts a process; getting a process identifier of the process; forming a namespace path which includes at least the process identifier; obtaining a namespace identifier of the process by utilizing at least the namespace path; and ensuring that the namespace map data structure includes an entry containing the process identifier and the namespace identifier.

In some embodiments, the method includes adding a sub-path /proc/[PID]/[NS]/root to a path of a container, where [PID] represents a process identifier of the container and [NS]/ is null or represents a namespace category.

In some embodiments, detecting at least two events in the computing system includes receiving a filesystem activity event through a fanotify listener.

In some embodiments, the method includes: injecting a thread into an alias namespace; placing a fanotify mark on a file, thereby acquiring an event handle; removing the alias namespace; and detecting at least two events in the computing system includes detecting at least one event in the computing system via the event handle. The alias namespace is a new namespace created in the global root namespace which is modified to have the namespace identifiers in effect at the hierarchy position of the target namespace process where the thread will be injected, and thus is effectively moved to that position in the hierarchy. The injected thread returns a handle to the caller and exits, the system cleans up after the thread exits, but the handle remains valid so the caller can listen for events using that handle.

In some embodiments, detecting at least two events in the computing system includes receiving an event from a user space probe in a container.

In some embodiments, the method includes: establishing a nesting relationship between two namespaces of the namespace set which are nested namespaces; and collapsing each of the nested namespaces to the same subtree root namespace.

With attention to FIG. 8, in one example an embodiment collapses system-userdbd 593 into systemd 221. Similarly, an event x in system-resolve 323 and an event y in system-userdbd 593 occur in different namespaces but processes 323 and 593 share a parent namespace 221, so one embodiment looks at x and y as a set to see if they collectively pose a risk, e.g., by matching an attack pattern.

In some embodiments, user-space applications with root privileges can register with a Fanotify subsystem using system calls. Upon registration, a user application gets a File Descriptor to read file events using a read system call and provide a verdict back to the Fanotify subsystem using a write system call. While issuing system calls (read/write) the application uses the same File Descriptor that it received during registration. Every file event received has a unique event ID. As a container runs in its own filesystem namespace, its file events are not available to a global filesystem namespace where the application is registered with Fanotify. To address this lack of event visibility, some embodiments operate as follows.

Register with a container manager (e.g., a Docker® container manager), e.g., by using a Unix Domain Socket (UDS) mechanism, to receive container start/stop/pause events.

The container manager provides container context information in the message during IPC, such as a unique container ID.

An antivirus (AV) application (for example) running on a Machine/VM registers with the container manager using UDS and waits for a container start event and receives process ID information of the container.

Upon receiving the container start event, the antivirus application forks a child process. The child process:
a. Opens a file descriptor (FD referring to CGROUP namespace) of file/proc/<container_process_ID>/ns/cgroup
b. Opens a file descriptor (FD referring to Process ID namespace) of file/proc/<container_process_ID>/ns/pid
c. Opens a file descriptor (FD referring to MOUNT namespace) of file/proc/<container_process_ID>/ns/mnt
d. Issues a setns( ) system call 3 times to reassociate the current child process with the CGROUP, PID, MOUNT namespaces of given File Descriptor
e. The child process is now running in the same CGROUP, PID, MOUNT namespaces as the container.
   i. Starts registration with the Fanotify subsystem using fanotify_init( ) and fanotify_mark( ) system calls.
      1. These calls are now registering containers “/” (root) filesystem with the kernel.
      2. Upon successful registration it returns the Fanotify File Descriptor.
f. The child process creates a Unix Domain Socket (UDS) and connects to the parent process which is listening on the same.
g. The child process passes the Fanotify File Descriptor to the parent process which is running in the global namespace (Machine/VM) in a form of control message leveraging the fact that FDs can be passed on to the parent process using Inter Process Communication (IPC)

Alternative A. Then the parent process issues read( ) system call(s) to start intercepting Container file events (Open and Close). It appends Container context information to the file event and passes it on to the AV engine for processing. The AV engine provides the verdict back to the parent process after completing the vetting process. The parent process issues 214 write( ) system call(s) to ALLOW/DENY file access based on the verdict provided by AV engine.

Alternative B. Then the Fanotify monitoring thread issues read ( ) system calls to start intercepting Container file events (Open and Close). It checks if the event belongs to a container (and which container, in the case of multiple containers) using/proc file system (/proc/<pid>/cgroup). If the event belongs to a container it fetches the context information. This file contains container ID information. For example:
$ cat/proc/27771/cgroup
NSpid:docker:<containerID>
7:hugetlb:/
6:cpuset:/
5:cpu,cpuacct:/
4:devices:/user.slice
3:rdma:/
2:memory:/
1:name=systemd:/user.slice/user-1000.slice/session-7491.scope
0::/user.slice/user-1000.slice/session-7491.scope

The embodiment also patches the file path to make it an absolute path which can be accessed outside the container by security tools running on a host. Then the embodiment puts that event on an event queue for AV engine processing. The AV engine provides the verdict back to the parent process after completing the vetting process (i.e., is or is not malware). The parent process issues 214 write( ) system call(s) to ALLOW/DENY file access based on the verdict provided by the AV engine. Whenever it receives a Container stop/pause event from the container manager, the embodiment removes container Fanotify FD from the fanotify monitoring loop.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as detecting 1102 events without employing human senses or human actions, determining 1104 namespaces without employing human senses or human actions, ascertaining 1106 that events occurred in different namespaces without employing human senses or human actions, calculating 1108 a risk score without employing human senses or human actions, and performing 1202 a cybersecurity operation without employing human senses or human actions, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., map 216, handle 240, string 232, and other data structures 218, event detector 302, namespace ascertainer 304, risk scorer 306, security tools 308, listener 1002, and probe 1006. None of these are mental concepts or present merely on paper.

In addition, some of the technical effects discussed include, e.g., determination 1104 via a namespace creation process which is an ancestor of an event process of a namespace where an event occurred even after the event process has terminated, risk scoring 1108 based on ascertaining that an event set spans multiple namespaces, and visibility from a root namespace into a container namespace via a listener 1002 or a probe 1006. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that event 134 detection 1102, namespace 234 determination 1104, hierarchy 230 or 238 traversal to locate 1314 an ancestor 1016, namespace 234 creation, thread 1054 injection 1322, operation 214 performance 1202, and other computational activities described herein are each a technical activity which cannot be performed mentally at all, because the mechanisms in question lack I/O devices that would allow a human to somehow “read” or “write” values within the computing system as described. People do not manually detect 1102 events, determine 1104 their namespace(s), or calculate 1108 risk scores as a practical matter. Hence, computing technology operational improvements such as the various examples of CNRA functionality 204 described herein are improvements to computing technology. People manifestly lack the speed and the digital communication and computation capabilities which are required to perform CNRA as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as Microsoft Defender™ for Endpoint plug-in for Windows Subsystem for Linux® 2 (WSL2™), Microsoft Defender™ for Containers, or other anti-malware solutions (marks of Microsoft Corporation, Linus Torvalds, respectively). The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed relevant to a particular embodiment. However, it does not follow from the availability of a broad context that exclusive rights are being sought herein for abstract ideas; they are not. In particular, no claim is made to anti-malware activities generally, or event monitoring activities generally, as opposed to the particular CNRA methods, systems, and devices described and claimed in the eventual final claims based on the present disclosure.

Rather, the present disclosure is focused on providing appropriately specific embodiments whose technical effects fully or partially solve particular technical problems, such as how to assess risk when different parts of an attack are sometimes coordinated to occur in different namespaces, and how to determine which namespace(s) events occurred in when visibility into some namespaces is restricted. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human actions per se. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Cybersecurity operations such as event detection, namespace determination, risk scoring, and many other operations discussed herein (whether recited expressly in the Figures or not), are understood to be inherently non-human. A human mind cannot interface directly with a computing device to perform the CNRA steps 1300 taught herein. This would all be well understood by persons of skill in the art in view of the present disclosure. Moreover, one of skill understands that CNRA functionality 204 cannot be implemented merely with conventional tools and steps, because actual implementation requires the use of teachings which were first provided in the present disclosure, e.g., CNRA teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical or prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, such as acquiring, ascertaining, assessing, calculating, communicating, creating, detecting, determining, executing, finding, generating, identifying, injecting, invoking, listening, locating, matching, nesting, performing, probing, receiving, translating (and acquires, acquired, ascertains, ascertained, etc.) with regard to a destination or other subject may involve intervening action, such as the foregoing or any action recited in this disclosure or inherent in a step recited in this disclosure, yet still be understood as being performed directly by or on behalf of the party of interest. Example verbs listed here may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, all of the ascertaining, all of the detecting, and all of the determining described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A relevant distinction in this example is that a computing system 102 contains one or more machines 101, whereas reference numeral 101 refers to a single machine, e.g., a single laptop, a single smartphone, a single workstation, a single Internet of Things device, etc. Similarly, particular kinds of data are referred to on occasion with two reference numbers, one of which is 228 indicating identifiers generally, and the other of which refers to a particular category of identifier, e.g., namespace identifiers 236. However, reference numerals for more general categories are often omitted herein for better readability, particularly when one of skill would acknowledge that the more general category encompasses a more specific category whose reference numeral is recited.

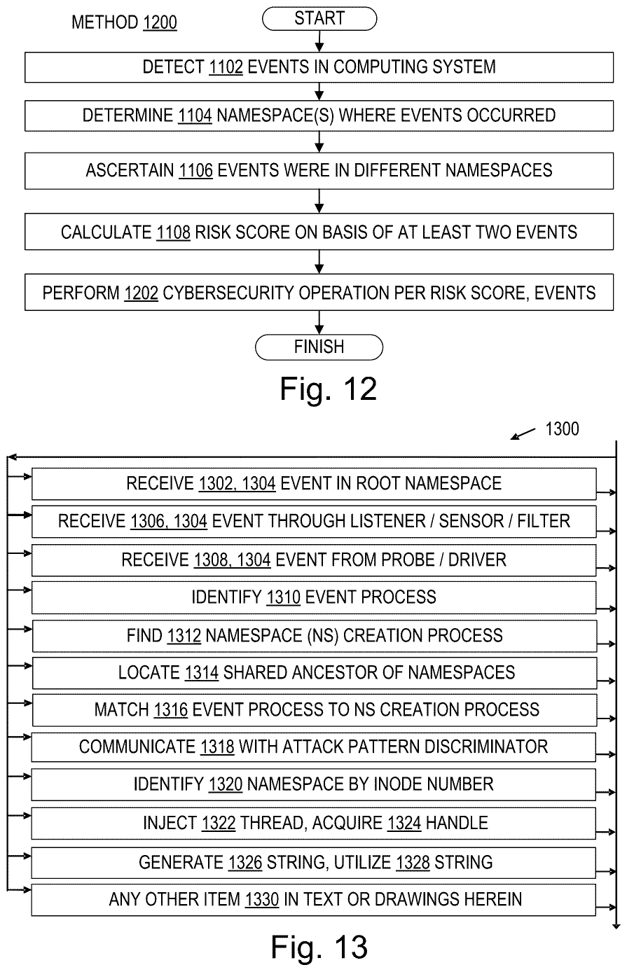

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, CIDFP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
134 event generally, as represented in a computing system
202 enhanced system, i.e., system 102 enhanced with functionality 204 as taught herein
204 cross-namespace risk assessment functionality (also referred to as functionality 204, or CNRA functionality), e.g., a mechanism which performs or is configured to perform steps 1104, 1106, and 1108, or steps 1110 and 1202, or any mechanism which performs or is configured to perform a sequence of risk assessment activities or event monitoring and classification activities or both, first disclosed herein, or to perform a novel method 1300 first disclosed herein
206 cross-namespace, as opposed to within a single namespace
208 risk assessment, as implemented within a computing system
210 cross-namespace risk assessment, as opposed to other security activities
212 cybersecurity, also referred to as security
216 map data structure reference numeral for a data structure in computing system memory consistent with FIG. 5; 216 coincidentally also identifies a particular process in the example process tree shown in FIGS. 7 and 8
218 data structure generally; not a human mental construct but rather resides in a computing system
1060 interface generally, e.g., network interface card, API, user interface, or other mechanism by or through which separable items communicate in a computing system, where examples of separable include physically separable, separately compilable, separately installable, or separably replaceable without loss of functionality
1100 flowchart; 1100 also refers to CNRA methods that are illustrated by or consistent with the FIG. 11 flowchart or any variation of the FIG. 11 flowchart described herein
1200 flowchart; 1200 also refers to CNRA methods that are illustrated by or consistent with the FIG. 12 flowchart or any variation of the FIG. 12 flowchart described herein
1300 flowchart; 1300 also refers to CNRA methods that are illustrated by or consistent with the FIG. 13 flowchart, which incorporates the flowcharts of FIG. 11 and FIG. 12, the steps implicit or express in FIGS. 1 through 10, and all other steps taught herein, or methods that are illustrated by or consistent with any variation of the FIG. 13 flowchart described herein; all CNRA method steps are computational or otherwise artificial, not human activity
1304 receiving an event, as performed in a computing system, e.g., via an API, shared memory, or other communication mechanism exclusive of human action
1330 any step or item discussed in the present disclosure that has not been assigned some other reference numeral; 1330 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Some embodiments receive events 134 in a computing system 202, map 502 the events to one or more namespaces 234 in which the events occurred, determine 1106 a relationship 1064 between the namespace(s) 234, and factor 1108 in the namespace relationship 1064 as well as the events 134 themselves when they assess 1110 a security risk 130 posed by the events. For example, namespaces 234 that share an ancestor 1016 namespace tree 1032 root 1068 below a global root 1066 are related. Some embodiments map 502, 1310 an event 134 to an event process 1012 and then to 1312 a namespace creation process 1014, and finally to a namespace 234. Some embodiments match 1318 events 134 which occurred in different container 136 namespaces 234 to an attack pattern 220, thereby detecting 222 an attack 1022 that would have been missed at that point by failing to treat events in different namespaces as though they are coordinated 1112 with each other.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some examples, the teachings herein are not limited to use in technology supplied or administered by Microsoft. Under a suitable license, for example, the present teachings could be embodied in hardware provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A cybersecurity method performed by a computing system, the method comprising:
detecting at least two events in the computing system;
for each event in a non-empty set of events which includes the at least two detected events, determining a namespace in which the event occurred;
ascertaining whether the events in the non-empty set of events occurred in different namespaces than each other;
calculating a risk score from at least one of the events in the non-empty set of events and from at least a result of the ascertaining; and
performing a cybersecurity operation according to at least the risk score.

2. The method of claim 1, wherein:
namespaces in the computing system are arranged in a namespace hierarchy which comprises a root namespace and at least one non-root namespace;
the at least two events occurred outside the root namespace; and
the detecting comprises receiving the at least two events in the root namespace.

3. The method of claim 1, wherein the detecting comprises at least one of:
receiving a filesystem activity event through a fanotify listener;
receiving a filesystem activity event through an inotify listener;
receiving an event from a Berkeley Packet Filter sensor;
receiving an event from a sensor;
receiving an event from a driver; or
receiving an event from a user space probe which is in a container.

4. The method of claim 1, wherein determining the namespace in which the event occurred comprises:
identifying an event process in which the event occurred;
finding a namespace creation process which created the namespace in which the event occurred, the namespace creation process being either the event process or an ancestor of the event process in a process hierarchy in the computing system; and
determining the namespace from at least the namespace creation process.

5. The method of claim 1, wherein the ascertaining ascertains that the events occurred in different namespaces than each other, and wherein the calculating calculates the risk score by at least one of:
assessing a risk due to the events as though the events occurred in the same namespace as each other;
assessing a risk due to the events as though the events were instigated by a same threat actor as each other;
assessing a risk due to the events as though the events were coordinated with each other; or
assessing a risk due to the events as though the events belong to a same attack as each other.

6. The method of claim 5, wherein the ascertaining ascertains that the events occurred in different container namespaces than each other, and wherein each container namespace corresponds to a respective container, each container comprising an application program and any code the application program is configured to invoke upon execution of the application program.

7. The method of claim 1, wherein namespaces in the computing system are arranged in a namespace hierarchy, and the ascertaining comprises locating a shared ancestor of the namespaces in the namespace hierarchy, the shared ancestor being a container namespace which corresponds to a container, the container comprising an application program and any code the application program is configured to invoke upon execution of the application program.

8. A computing system, comprising:
a digital memory;
a processor in operable communication with the digital memory;
a map data structure residing in the digital memory, the map data structure comprising an association of namespace identifiers with corresponding process identifiers;
a set of instructions which is not empty, the set of instructions representing a sequence of cybersecurity steps which upon execution by the processor: detect at least two events in the computing system, identify for each event in a non-empty set of events a respective event process in which the event occurred, determine for each event in the non-empty set of events through use of at least the map data structure a namespace in which the event occurred, ascertain whether the events in the non-empty set of events occurred in different namespaces than each other, calculate a risk score from at least the at least two events and from at least a result of the ascertaining, and perform a cybersecurity operation according to at least the risk score.

9. The computing system of claim 8, wherein a process identifier in the map data structure identifies a namespace creation process which created the namespace identified by the associated namespace identifier, the sequence of cybersecurity steps comprises matching the event process to the namespace creation process, and the namespace creation process is either the event process or an ancestor of the event process in a process hierarchy in the computing system.

10. The computing system of claim 9, wherein the process hierarchy has a single global root which is an ancestor of all processes in the computing system, and the namespace creation process is positioned in the process hierarchy below the global root of the process hierarchy.

11. The computing system of claim 8, further comprising an attack pattern discriminator, wherein the computing system ascertains that the events occurred in different namespaces than each other, and the computing system submits the events together to the attack pattern discriminator.

12. The computing system of claim 8, wherein each event process is in a process hierarchy in the computing system which includes a process tree of process nodes which represent processes, each namespace is in a namespace hierarchy in the computing system which includes a namespace tree of namespace nodes which represent namespaces, the namespace tree corresponds to a proper subtree of the process tree, and the sequence of cybersecurity steps matches two process nodes to a same namespace node which corresponds to a shared ancestor of the two process nodes.

13. The computing system of claim 12, wherein each namespace in which a detected event occurred is identified by an inode number.

14. The computing system of claim 12, wherein the detected events occurred in different namespaces than each other, and each namespace in which a detected event occurred comprises a respective container namespace which corresponds to a respective container.

15. The computing system of claim 8, wherein the namespace in which the event occurred comprises at least one of: a process namespace, a mount namespace, a network namespace, an inter-process communication namespace, a time sharing namespace, a user namespace, a control group namespace, a time namespace, or a journal namespace.

16. A computer-readable storage medium configured with data and instructions which upon execution by a processor of a computing system perform a cybersecurity method, the method comprising:
detecting a first event in the computing system;
detecting a second event in the computing system, the second event different than the first event;
determining a first namespace in which the first event occurred;
determining a second namespace in which the second event occurred;
ascertaining that the first namespace and the second namespace are different namespaces than each other;
calculating a risk score from at least the first event and the second event; and
performing a cybersecurity operation according to at least the risk score.

17. The computer-readable storage medium of claim 16, wherein the method further comprises injecting a thread which is configured to upon execution acquire a handle, and wherein the detecting comprises detecting at least one of the first event or the second event via the handle.

18. The computer-readable storage medium of claim 16, wherein the method comprises mapping a process identifier to a namespace identifier which identifies the namespace in which at least one of the first event or the second event occurred.

19. The computer-readable storage medium of claim 16, wherein the method comprises generating a string “/proc/[pid]/ns/pid” in which [pid] is an identifier of a process in which at least one of the first event or the second event occurred, and utilizing the string to determine the namespace in which said event occurred.

20. The computer-readable storage medium of claim 16, wherein each of the different namespaces is the namespace of a respective container, and wherein at least one of:
the respective containers are each nested within a third container; or
one of the respective containers is nested within another of the respective containers.
